(19) United States
(12) Patent Application Publication
(10) Pub. No.: US 2010/0124372 A1
(43) Pub. Date: May 20, 2010

(54) Methods and systems for identifying/accessing color related information

(75) Inventor: Dustin T. Parr, Apalachin, NY (US)

Correspondence Address: BURNS & LEVINSON, LLP, 125 SUMMER STREET, BOSTON, MA, 02110, US

(73) Assignee: Lockheed Martin Corporation, Bethesda, MD (US)

(21) Appl. No.: 12/590,709

(22) Filed: Nov. 12, 2009

Related U.S. Application Data
(60) Provisional application No. 61/113,860, filed on Nov. 12, 2008.

(51) Int. Cl. G06K 9/00

(52) U.S. Cl. 382/165

(57) ABSTRACT

In one instance, the method of these teachings for identifying/accessing color related information includes generating, for a color image, a number of color clusters in a color space (e.g. RGB, HSV, CYMK, LUV, etc.), assigning each pixel in the image to one of the clusters, and separating the information identified with the color of the cluster; thereby identifying/accessing the color related information.

### CROSS REFERENCE TO RELATED APPLICATIONS

This application claims priority of co-pending U.S. Provisional Application Ser. No. 61/113,860 filed Nov. 12, 2008, entitled METHODS FOR IDENTIFYING/ACCESSING COLOR RELATED INFORMATION, which is incorporated herein by reference in its entirety.

### BACKGROUND

These teachings relate generally to identifying/accessing color related information.

In a variety of applications, different colors of text or regions in an image indicate temporal, logical and/or contextual differences. “Color related/indicated information,” as used herein refers to the temporal, logical or contextual information indicated by a particular color in an image, the information not being the color itself. For example, if the image is used for the purposes of quality control, different colors could indicate scorching, excess adhesive remaining, etc. In another example, the image of a specified organ or body part would be different for a healthy or diseased organ or body part and the differences in the image can be represented or can appear as regions of different colors.

If the colors present are known a priori, segmentation/identification is fairly straightforward task. But in the general case, i.e. an image that can contain any or all colors, one is forced to pre-select how we would like to partition them without the benefit of seeing the image first and this can result in sub-optimal results.

There is, therefore, a need to provide unsupervised methods for identifying/accessing color related or color indicated information, where the indicated or related information is not to color itself.

### BRIEF SUMMARY

In one embodiment, the method of these teachings for identifying/accessing color related information includes generating, for a color image, a number of color clusters in a color space (e.g. RGB, HSV, CYMK, LUV, etc.), assigning each pixel in the image to one of the clusters, and separating the information identified with the color of the cluster; thereby identifying/accessing the color related/indicated information, where the color related/indicated information is not the color itself.

Other embodiments of the method of these teachings and embodiments of the system to implement the method of these teachings are disclosed.

For a better understanding of the present teachings, together with other and further needs thereof, reference is made to the accompanying drawings and detailed description and its scope will be pointed out in the appended claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIGS. 1-3 are schematic flow chart representations of embodiments of the method of these teachings;

FIGS. 4a and 4b are schematic block diagram representations of embodiments of the system of these teachings; and

FIGS. 5a-5c represent exemplary embodiments of applications of the method of these teachings.

### DETAILED DESCRIPTION

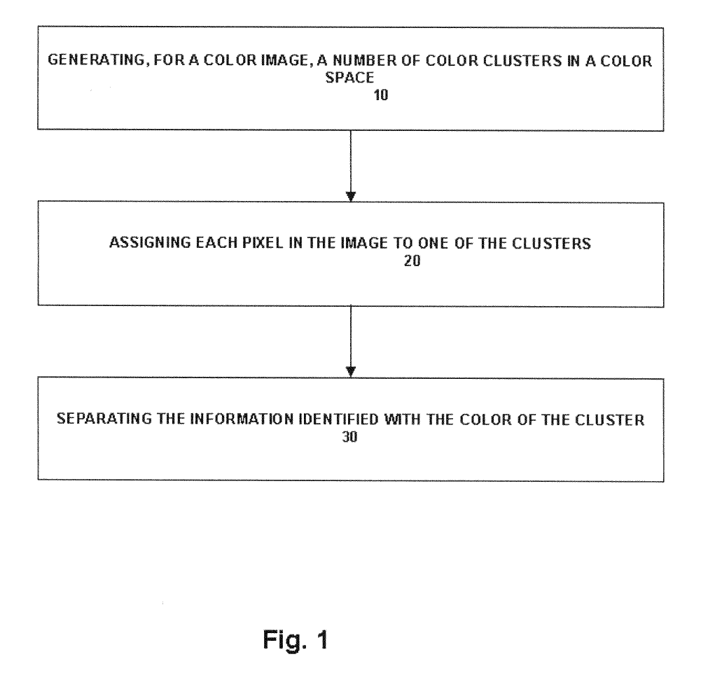

FIGS. 1-3 show schematic flow chart representations of embodiments of the method of these teachings.

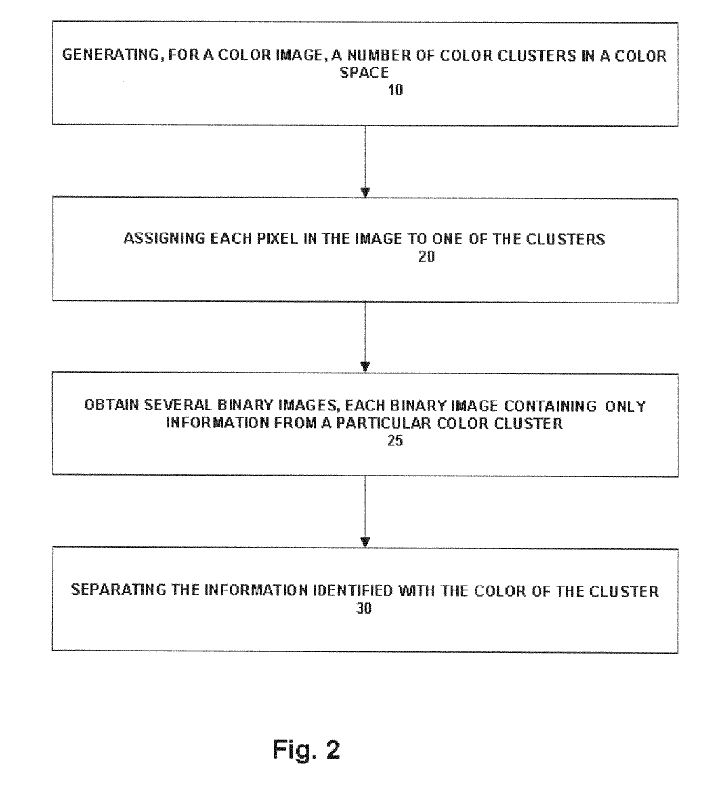

Referring to FIG. 1, for a color image, a preselected form of clustering (e.g., but not limited to, k-means, agglomerative, etc.; see, for example, but not limited to, Coleman, G. B, Andrews, H. C., Image segmentation by clustering, Proceedings of the IEEE, Volume 67, Issue 5, May 1979 Page(s): 773-785 and Lucchese, L., Mitra, S. K, Unsupervised segmentation of color images based on k-means clustering in the chromaticity plane, Proceedings. IEEE Workshop on Content-Based Access of Image and Video Libraries, 1999 (CBAIVL '99), 1999, Pages: 74-78, both of which incorporated by reference herein in their entirety, and references provided therein) is used to generate a number of color clusters in a color space (e.g. but not limited to, RGB, HSV, CYMK, Luv, Lab etc.) (10, FIG. 1). In embodiments utilizing a distance metric, the distance metric could be a distance metric ranging from, for example, but not limited to, a Euclidian distance to a tunable, weighted metric. (Exemplary embodiments of distance metrics include, but are not limited to, Euclidian metrics, Maximum Norm metrics, Manhattan metrics, Mahalanobis metrics and Hamming metrics.) Once the cluster centroids have been created, each pixel in the image is assigned to one of the clusters based on the previously chosen distance metric (20, FIG. 1). (Cluster centroids and distance metric are conventionally utilized with clustering algorithms such as the k-means clustering algorithm. In one instance, after assigning each pixel in the image to a cluster, bitmasks of each segment can be created, resulting in several binary images (25, FIG. 2), each binary image contains only information from a particular color cluster. Thereby, the information identified with the color of the cluster (based on the same information as the colors themselves represented) is separated (30, FIG. 1), whereby the color related/indicated information, the information not being the color itself, is identified/accessed or additional contextual information is extracted from the color related/indicated information.

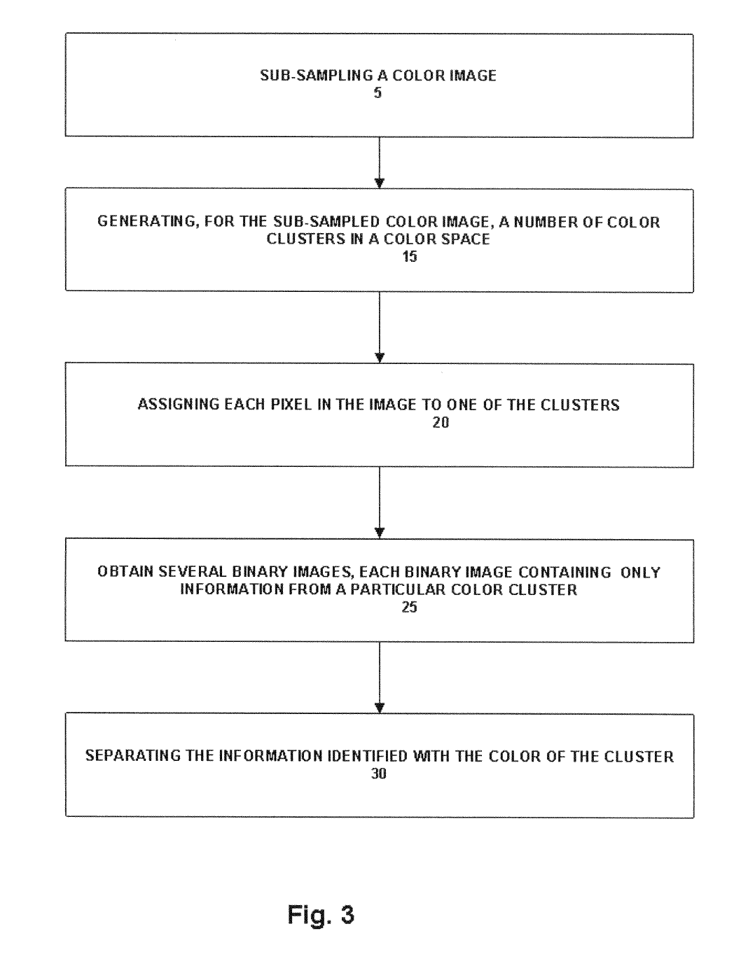

For large or high resolution images, in one embodiment, shown in FIG. 3, the color image is sub-sampled, resulting in a sub-sampled color image (5, FIG. 3). For the sub-sampled color image, a preselected form of clustering is used to generate a number of color clusters in a color space (15, FIG. 3). The method then proceeds as FIG. 1 or 2.

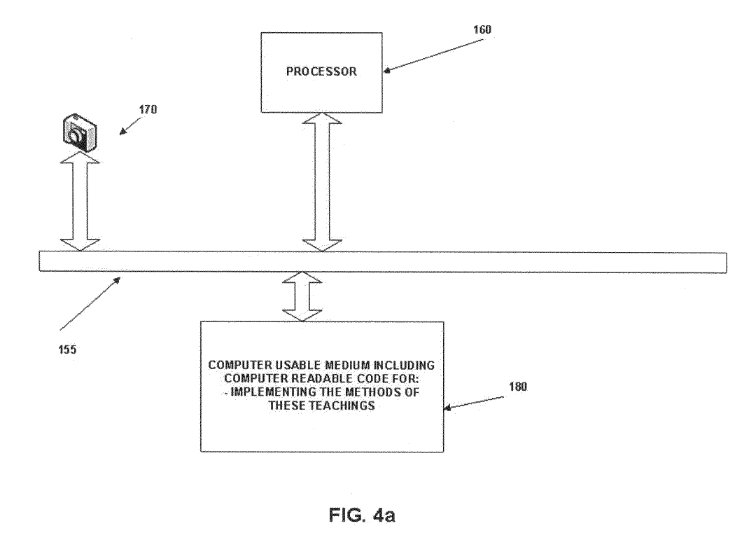

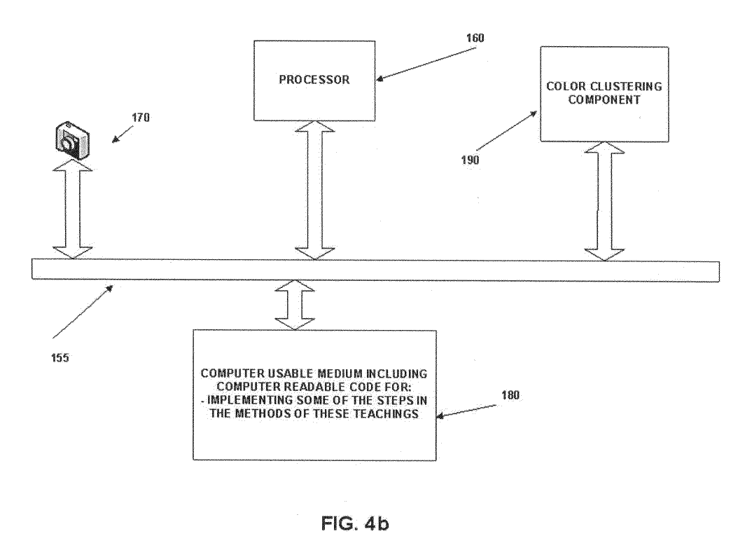

In one embodiment, shown in FIG. 4a, interface component(s) and camera(s) (170, FIG. 4), (also referred to as an image acquisition system) provide the color image to one or more processors 160 and one or more computer usable media 180 having computer readable code embodied therein to cause the one or more processors 160 to implement the methods of these teachings. It should be noted that, although FIG. 4 shows one processor and one memory operatively connected by connection component 155 (in one instance, a computer bus), distributed embodiments in which the camera and interface component 170 also includes one or more processors and one or more computer usable media are also within the scope of these teachings.

In other embodiments of the system to implement the method of these teachings, one or more of the steps in the embodiment of the method of these teachings are performed by hardware. For example, the step of number of generating a number of color clusters in a color space can be performed by dedicated hardware (see for example, but not limited to, T. Saegusa, T. Maruyama, Real-Time Segmentation of Color Images based on the K-means Clustering on FPGA, International Conference on Field-Programmable Technology, 2007. ICFPT 2007, 12-14 Dec. 2007, Pages: 329-332, which is incorporated by reference herein in its entirety). In another embodiment of the system of these teachings, shown in FIG. 4b, a dedicated clustering component 190 generates the number of color clusters while the other steps in the method of these teachings are implemented by means of computer readable code embedded in a computer usable medium 180, where the computer readable code causes the processor 160 to implement the other steps in the method.

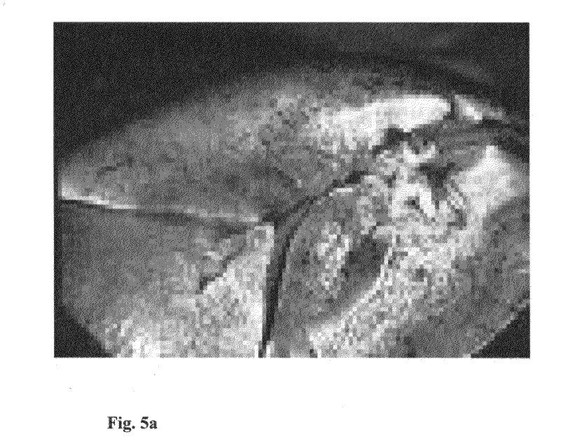

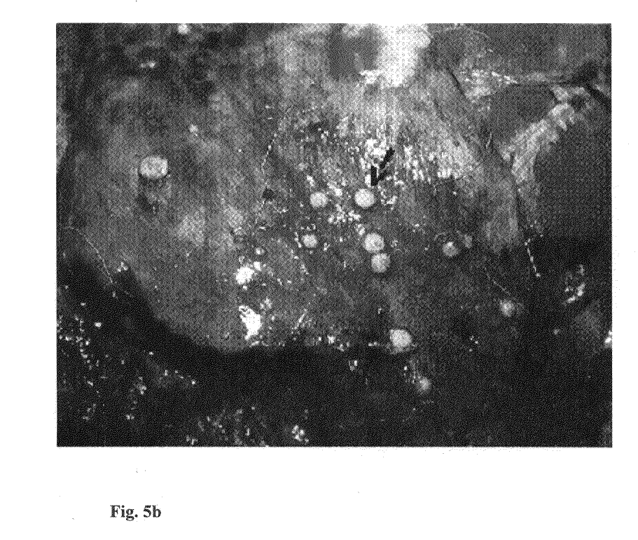

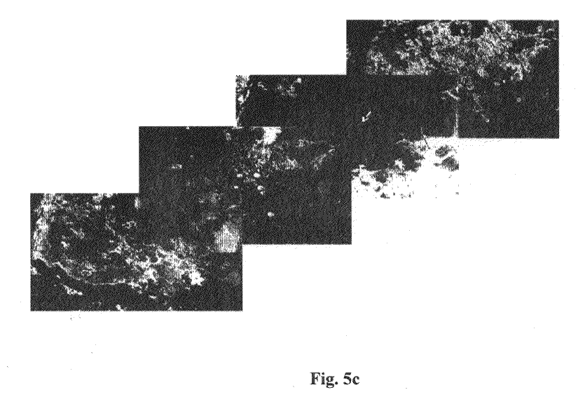

In order to better illustrate the present teachings, an exemplary application of one embodiment of the method of these teachings is described hereinbelow. An image of a healthy organ from an animal shown in FIG. 5a and an image of a diseased organ is shown in FIG. 5b (the image shown in FIG. 5b was obtained from http://www.michigan.gov/emergingdiseases/0,1607,7-186-25804-76392--,00.html). As shown in FIG. 5c, the image shown in FIG. 5b, by application of the methods shown in FIGS. 1-3, can be decomposed into several binary images (25, FIG. 2), each binary image containing only information from a particular color cluster. The disease characteristic can be identified from one image from the images containing only information from a particular color cluster. Identifying the disease characteristics is an exemplary embodiment of extracting additional contextual information from the color information, where traditionally extracted information is not the color itself. Embodiments in which additional components are utilized it again to extract the additional contextual information (such as neural networks, etc.) are also within the scope of these teachings. In one embodiment, the method includes filtering one or more of the images containing only information from a particular color cluster in order to aid in the identification.

The techniques described above may be implemented, for example, in hardware, software, firmware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to data entered using the input device to perform the functions described and to generate output information. The output information may be applied to one or more output devices.

Elements and components described herein may be further divided into additional components or joined together to form fewer components for performing the same functions.

Each computer program may be implemented in any programming language, such as assembly language, machine language, a high-level procedural programming language, or an object-oriented programming language. The programming language may be a compiled or interpreted programming language.

Each computer program may be implemented in a computer program product tangibly embodied in a computer-readable storage device for execution by a computer processor. Method steps of the invention may be performed by a computer processor executing a program tangibly embodied on a computer-readable medium to perform functions of the invention by operating on input and generating output.

Common forms of computer-readable media include, for example, a floppy disk, a flexible disk, hard disk, magnetic tape, or any other magnetic medium, a CDROM, any other optical medium, punched cards, paper tape, any other physical medium with patterns of holes, a RAM, a PROM, and EPROM, a FLASH-EPROM, any other memory chip or cartridge, or any other medium from which a computer can read. From a technological standpoint, a signal or carrier wave (such as used for Internet distribution of software) encoded with functional descriptive material is similar to a computer-readable medium encoded with functional descriptive material, in that they both create a functional interrelationship with a computer. In other words, a computer is able to execute the encoded functions, regardless of whether the format is a disk or a signal.

Although these teachings have been described with respect to various embodiments, it should be realized these teachings is also capable of a wide variety of further and other embodiments within the spirit and scope of the appended claims.

What is claimed is:

1. A method for identifying/accessing color related/indicated information, the information not being a color itself, the method comprising the steps of:
generating, for a color image, utilizing a clustering component, a number of color clusters in the color space;
assigning each pixel in the color image to one of the color clusters; and
separating the information indicated by color in the color clusters;
color related/indicated contextual information being identified/accessed.

2. The method of claim 1 further comprising the step of:
obtaining, after assigning each pixel in the color image to one of the color clusters, a number of binary images, each binary image containing information from one color cluster;
binary images in the number of binary images being obtained by means of a computer usable medium having computer readable code that causes at least one processor to implement the method.

3. The method of claim 2 further comprising the step of subsampling the color image; and wherein, in the step of generating a number of color clusters, the color clusters are generated for the subsampled color image.

4. The method of claim 2 further comprising the step of:
filtering at least one binary image from the number of binary images.

5. The method of claim 1 wherein the step of assigning each pixel in the color image to one of the color clusters comprises the steps of:
obtaining, by means of a computer usable medium having computer readable code that causes at least one processor to implement the method, a cluster centroid for each color cluster;
assigning each pixel to one of the color clusters based on a distance from each pixel to the cluster centroid of each color cluster.

6. A system for identifying/accessing color related/indicated information in a color image, the information not being a color itself, the system comprising:
an image acquisition device acquiring the color image;
an image processing subsystem comprising:
a clustering component generating a plurality of color clusters in a color space from the color image;
at least one processor; and
at least one computer usable medium having computer readable code embodied therein, the computer readable code causing said at least one processor to:
assign each pixel in the color image to one of the color clusters; and
separate the information indicated by color in the color clusters;
color related/indicated contextual information being identified/accessed.

7. The system of claim 6 wherein said clustering component comprises computer readable code embodied in said at least one computer usable medium, said computer readable code causing said at least one processor to generate said plurality of color clusters in the color space from the color image.

8. A computer program product comprising a computer usable medium having computer readable code embodied therein; said computer readable code causes at least one processor to:
assign each pixel in the color image to one of the color clusters; and
separate the information indicated by color in the color clusters;
color related/indicated contextual information being identified/accessed.

9. The computer program product of claim 8 wherein said computer readable code also causes said at least one processor to:
obtain, after assigning each pixel in the color image to one of the color clusters, a number of binary images, each binary image containing information from one color cluster.

10. The computer program product of claim 9 wherein said computer readable code also causes said at least one processor to:
subsample the color image; and
wherein, in generating a number of color clusters, said at least one processor generates the color clusters in the subsampled color image.

11. The computer program product of claim 9 wherein said computer readable code also causes said at least one processor to:
filter at least one binary image from the number of binary images.

12. The computer program product of claim 8 wherein said computer readable code also causes said at least one processor to:
obtain a cluster centroid for each color cluster;
assign each pixel to one of the color clusters based on a distance from each pixel to the cluster centroid of each color cluster.
